(19) United States
(12) Patent Application Publication
(10) Pub. No.: US 2014/0105698 A1
(43) Pub. Date: Apr. 17, 2014

(54) METHOD FOR SKIVING OF OUTER TOOTHINGS AND APPARATUS COMPRISING AN ACCORDING SKIVING TOOL

(71) Applicant: Olaf Vogel, Ettlingen (DE)

(72) Inventor: Olaf Vogel, Ettlingen (DE)

(73) Assignee: Klingelnberg AG, Zurich (CH)

(21) Appl. No.: 14/122,638

(22) PCT Filed: May 15, 2012
(86) PCT No.: PCT/EP2012/059062

§ 371 Date: Nov. 26, 2013

(30) Foreign Application Priority Data
May 26, 2011 (EP) 11 167 703.5
Jul. 14, 2011 (EP) 11 173 901.7

(51) Int. Cl. B23F 5/16

(52) U.S. Cl. CPC B23F 5/163
USPC 409/36

(57) ABSTRACT

A method and an apparatus for skiving a work piece having an outer rotationally symmetric periodic structure by applying a skiving tool. The skiving tool is an inside skiving ring spanning an interior space that includes a plurality of cutting teeth. At least one cutting edge, one cutter head tip and one cutting face are provided on each cutting tooth. The cutting faces of all the cutting teeth are arranged rotationally symmetric with respect to the rotational axis of the skiving tool on a front plane or a front side cone surface of the inside skiving ring, and the cutting teeth project into the interior space and point in the direction of the rotation axis.

### CROSS-REFERENCE TO RELATED APPLICATIONS

This application is the U.S. National Phase of International Application No. PCT/EP2012/059062, entitled “Method for Hob Peeling External Teeth and Device Having a Corresponding Hob Peeling Tool”, filed on May 15, 2012, which claims priority under 35 U.S.C. §119(a)-(d) from European Patent Application No. EP 11 173 901.7, filed Jul. 14, 2011, and from European Patent Application No. EP 11 167 703.5, filed May 26, 2011, the disclosures of which are hereby incorporated by reference in their entirety.

### FIELD OF THE INVENTION

The invention relates to a method for skiving an outer toothing or another outer periodic structure and an apparatus for skiving an outer toothing or another periodic structure comprising an according skiving tool.

### BACKGROUND OF THE INVENTION

There are numerous methods for manufacturing gear wheels. In the chip-producing soft pre-machining, one distinguishes hobbing, gear shaping, generating planing and skiving (in English also called power skiving). The hobbing and skiving are so-called continuous methods, as shall be explained in the following.

In the chip-producing manufacturing of gear wheels, one distinguishes between the intermitted indexing process or the single indexing process and the continuous method, which is sometimes also called a continuous indexing process or face hobbing.

In the continuous method, for example, a tool comprising cutters is applied in order to cut the flanks of a work piece. The work piece is cut in one clamping continuously, i.e., in an uninterrupted process. The continuous method is based on complex coupled movement sequences, in which the tool and the work piece to be machined perform a continuous indexing movement relative to each other. The indexing movement results from the driving of the tool in coordination with respect to the coupled driving of a plurality of axis drives of a machine.

In the single indexing process, one tooth gap is machined; then, for example, a relative movement of the tool and a so-called indexing movement (indexing rotation), in which the work piece rotates relative to the tool, are carried out, and then the next tooth gap is machined. In this way, a gear wheel is manufactured step by step.

The initially mentioned gear shaping method may be described or represented by a cylinder gear transmission, because the intersection angle (also called intersection angle of axes) between the rotation axis R1 of the shaping tool 1 and the rotation axis R2 of the work piece 2 amounts to zero degrees, as represented schematically in FIG. 1. The two rotation axes R1 and R2 run parallel, if the intersection angle of axes amounts to zero degrees. The work piece 2 and the shaping tool 1 rotate continuously about their rotation axes R2 respectively R1. In addition to the rotational movement, the shaping tool 1 carries out a stroke movement, which is referenced in FIG. 1 by the double arrow sₕₓ, and removes chips from the work piece 2 during this stroke movement.

Some time ago a method has been taken up anew, which is called skiving. The basics are aged approximately 100 years. A first patent application with the number DE 243514 on this subject dates back to the year 1912. After the original considerations and investigations of the initial years, skiving was no longer pursued further seriously. Hitherto, complex processes, which were partly empirical, were necessary in order to find a suitable tool geometry for the skiving method.

About in the middle of the nineteen eighties, skiving was taken up anew. It was not until the present-day simulation methods and the modern CNC-controls of the machines, that the principle of skiving could be implemented as a productive, reproducible and robust method. The high durability of present-day tool materials, the enormous high static and dynamical rigidity and the high performance of the synchronous running of the modern machines come in addition.

As shown in FIG. 2A, during skiving, an intersection angle of axes Σ between the rotation axis R1 of the skiving tool 10 (also called skiving wheel) and the rotation axis R2 of the work piece 20 is prescribed, which is different from zero. The resulting relative movement between the skiving tool 10 and the work piece 20 is a helical movement, which can be decomposed into a rotational portion (rotatory portion) and an advance portion (translational portion). A generation helical type gear transmission can be considered as a drive technology-specific analogon, wherein the rotational portion corresponds to the rolling and the advance portion corresponds to the gliding of the flanks. The greater the absolute value of the intersection angle of axes Σ, the more the translational movement portion required for the machining of the work piece 20 increases. It causes namely a movement component of the cutting edges of the skiving tool 10 in the direction of the tooth flanks of the work piece 20. Thus, during skiving, the gliding portion of the combined relative movement of the mutually engaging gear wheels of the equivalent helical gear is utilized to carry out the cutting movement. In skiving, only a slow axial feed sₐₓ (also called axial feed) is required and the so-called shaping (pushing) movement, which is typical for the gear shaping, is dispensed with. Thus, also a return stroke movement does not occur in skiving.

The cutting speed in skiving is influenced directly by the rotational speed of the skiving tool 10 relative to the work piece 20 and the utilized intersection angle of axes Σ between the rotation axes R1 and R2. The intersection angle of axes Σ and thus the gliding portion should be selected such that for a given rotational speed an optimum cutting speed is achieved for the machining of the material.

The movement sequences and further details of an established skiving method can be taken from the schematic representation in FIG. 2A that has already been mentioned. FIG. 2A shows the skiving of an outer toothing on a cylindrical work piece 20. The work piece 20 and the tool 10 (here a cylindrical skiving tool 10) rotate in opposite directions, as can be seen in FIG. 2A, e.g., on the basis of the angular velocities ω₁ and ω₂.

Further relative movements come in addition. The axial feed sₐₓ already mentioned is required in order to be able to machine with the tool 10 the entire toothing width of the work piece 20. The axial feed causes a shifting of the tool 10 with respect to the work piece 20 in a direction parallel to the rotation axis R2 of the work piece 20. The direction of this movement of the tool 10 is referenced in FIG. 2A with sₐₓ. If a helical toothing is desired on the work piece 20 (i.e., β₂≠0), a differential feed s_{D} is superimposed on the axial feed sₐₓ, which differential feed corresponds to an additional rotation of the work piece 20 about its rotation axis R2, as indicated in FIG. 2A. The differential feed s_{D} and the axial feed sₐₓ are tuned to each other at the calculation point AP such that the resulting feed of the tool 10 with respect to the work piece 20 occurs in the direction of the tooth gap to be generated. In addition, a radial feed s_{rad} may be employed in order to influence the crowning of the toothing of the work piece 20.

In skiving, the vector of the cutting speed \vec{v}_{c} results substantially as the difference of the two velocity vectors \vec{v}₁ and \vec{v}₂ of the rotation axes R1, R2 of the tool 10 and the work piece 20, which are tilted with respect to each other by the intersection angle of axes E. The symbol \vec{v}₁ is the velocity vector at the periphery of the tool and \vec{v}₂ is the velocity vector at the periphery of the work piece 20. The cutting speed v_{c} of the skiving process may thus be changed by the intersection angle of axes Σ and the rotation speed in the equivalent helical gear. In skiving, the axial feed sₐₓ, which is relatively slow as already mentioned, has only a small influence on the cutting speed v_{c}, which can be neglected. Therefore, the axial feed sₐₓ is not taken into account in the vector diagram comprising the vectors \vec{v}₁, \vec{v}₂ and \vec{v}_{c} in FIG. 2A.

The skiving of an outer toothing of a work piece 20 using a conical skiving tool 10 is shown in FIG. 2B. In FIG. 2B again, the intersection angle of axes E, the vector of the cutting speed \vec{v}_{c}, the velocity vectors \vec{v}₁ at the periphery of the tool 10 and \vec{v}₂ at the periphery of the work piece 20 as well as the helix angle β₁ of the tool 10 and the helix angle β₂ of the work piece 20 is shown. Here, in contrast to FIG. 2, the helix angle β₂ is different from zero. The tooth head of the tool 10 is referenced with the reference sign 4 in FIG. 2B. The tooth breast is referenced with the reference sign 5 in FIG. 2B. The two rotation axes R1 and R2 do not intersect, but are arranged skew with respect to each other. For a conical skiving tool 10, the calculation point AP is hitherto usually chosen on the joint plumb of the two rotation axes R1 and R2, because a tilting of the skiving tool 10 for providing of relief angles is not necessary. The calculation point AP coincides with the so-called contact point. The rolling circles of the equivalent helical generation gear contact each other in this calculation point AP.

For skiving, a tool is applied, which comprises at least one geometrically determined cutting edge. The cutting edge/cutting edges are not shown in FIG. 2A and FIG. 2B. The shape and arrangement of the cutting edges as well as the neighboring chipping surfaces and relief surfaces belong to those aspects which have to be taken into account in practice in a concrete implementation.

In the example shown in FIG. 2A, the skiving tool 10 has the shape of a straight-toothed spur wheel. The outer contour of the base body in FIG. 2A is cylindrical. However, it may also be conical (also called cone-shaped), as shown in FIG. 2B. Since the one or the plural teeth of the skiving tool 10 come into engagement over the whole length of the cutting edge, each tooth of the tool 10 requires a sufficient relief angle at the cutting edge.

When starting from a straight-toothed or a helically toothed conical skiving tool 10, as shown in the FIGS. 3A and 3B, then one recognizes that such a skiving tool 10 has so-called constructive relief angles due to the conical basic shape of the skiving tool 10, .i.e., the relief angle at the head and on the flanks of the conical skiving tool 10 are predetermined due to the geometry of the skiving tool 10. However, the profile of the cutting edge of a conical skiving tool 10, must obey certain conditions, in order to enable a re-shaping at all. In the FIGS. 3A and 3B, a conical skiving tool 10 is shown when generating an outer toothing on a work piece 20. The so-called constructional relief angle α_{Ko} at the cutter head of the conical skiving tool 10 is visible in FIG. 3B. The intersection point of axes AK and the contact point BP of the rolling circles of the skiving tool 10 and the work piece 20 coincide in FIG. 3A and lie on the joint plumb GL (shown in FIGS. 3A and 3B) of the rotation axes R1 and R2.

Investigations of previous skiving methods have shown that a significant wear of the skiving tool 10 may arise depending on the design of the skiving tool 10. Therefore, solutions are searched which enable reducing the wear of the skiving tool 10, respectively improving the durability of the skiving tool 10. For reducing the wear of the skiving tool 10, one may, for example, conceive as many cutting teeth on the tool 10 as possible. Thereby, the skiving method becomes more economic, because the manufacturing cost for toothing of work pieces 20 is influenced substantially by the tool life of the tools. For accommodating as many cutting teeth on the tool 10 as possible, the skiving tool 10 must be constructed as large as possible. Limits are set for the possible size of the usable skiving tools 10, in particular, by the utilized machining machine. Stated more precisely, a limitation exists in the work space of the machine as well as in the possible travelling distances of the axes with respect to the arrangement of the axes.

The problems which result due to the limitation of the work space are explained in more detail as follows with reference to the FIGS. 3A and 3B already described. In these two figures, a work piece 20 is shown that has an outer toothing according to DIN867 having a normal module 8 mm, a number of teeth 25 and a helix angle β₂=0 degrees, whereby the helix angle β₂ is not shown. This work piece 20 is to be machined by means of skiving subject to an intersection angle of axes Σ of 25 degrees with a common conical (outer) skiving tool 10 (without inclination). The diameter of the rolling circle of the work piece 20 amounts to 200 mm here. The work space AR in the direction of the distance between axes of the machining machine to be employed amounts to 600 mm. Due to these space-limiting conditions, the conical (outer) skiving tool 10 may comprise at maximum 44 cutting teeth, for a rolling circle diameter that is as large as possible at approximately 388 mm. Here, the distance AA between the axes amounts to approximately 294 mm.

The problems, which result due to the limitation of the distance between axes, respectively, the travelling distance of the axes of a machine, shall be explained in more detail in the following with reference to the FIGS. 4A and 4B. Again, the same outer toothing as in the FIGS. 3A and 3B shall be machined with an intersection angle of axes Σ of 25 degrees with a common conical (outer) skiving tool 10 (without inclination). Here, the rolling circle diameter of the work piece 20 amounts to 200 mm. In addition to the limitation of the work space, the traveling distances of the machining machine to be employed allow a maximum distance AA between axes of 200 mm. Then, the (outer) skiving tool 10 to be employed having a rolling circle diameter of the tool that is as large as possible at approximately 194 mm may comprise at maximum 22 cutting teeth. In this example, the maximum dimension of the (outer) skiving tool 10 is therefore only half as large as compared to the example shown in the FIGS. 3A and 3B. The distance AA between axes amounts to approximately 197 mm here.

For improving the tool life of the skiving tools 10, one may increase the number of the cutting teeth, as already mentioned. Ideally, one would not only increase the number of the cutting teeth, but one would equip the skiving tool 10 with regrindable cutter bars. Then, the cutter bars can be reground at the cutting teeth or they can even be exchanged in case of need. Also, this contributes to an improvement of the cost effectiveness. Here, however, one can achieve a high packing density of the cutter bars only as a result of a very complex arrangement of the cutter shafts of the cutter bars, as described for example in the German utility model application DE 202011050054.3, which has been filed on 6 May 2011 under the title “Wälzschälwerkzeug mit Messerstäben” (English: “skiving tool comprising cutter bars”).

Alternatively, it is possible to work with a partial equipment of the skiving tool 10 in order to avoid a penetration of the cutter shafts which results for a high packing density of the cutter bars. That is, not all the cutting teeth of a complete skiving wheel are formed, but e.g., only each second or third. Thereby, however, the factual number of cutting teeth is reduced, which is to the disadvantage of the tool life of the tool.

### SUMMARY OF THE INVENTION

It is an object of the present invention to provide a method and an apparatus for the chipping machining of the tooth flanks of a tooth wheel or other periodic outer structures, which feature a reduction of the production cost per tooth wheel or work piece.

Of particular concern is to ensure a number of cutting teeth and thus a tool life that are as high as possible under the restrictions of the work space and the travelling distances of the machining machine to be employed.

Of particular concern is to keep the tool cost as low as possible by improving the tool life of the tools.

Preferably, the cutting teeth of the skiving tools shall be formed by regrindable cutter inserts (e.g., in the form of cutter bars).

The object is solved according to the present invention by a method, which is called inside skiving method herein.

The inside skiving method can be utilized in relation to the manufacturing of rotationally symmetrical, periodical, outer structures, such as outer toothings and the like.

In the inside skiving method, a skiving tool is applied, which shall be called inside skiving ring due to its special constructional shape.

According to the invention, a method and an apparatus for skiving a work piece with an outer, rotationally symmetric periodic structure by applying a skiving tool is concerned. The following steps are performed:
rotating the skiving tool about a first rotation axis,
coupledly rotating the work piece about a second rotation axis, and
performing an axial feed movement of the skiving tool with respect to the work piece in a direction parallel to the second rotation axis,
   whereby the two rotation axes are set with an intersection angle of axes skew relative to each other during the skiving. The skiving tool is an inside skiving ring, which spans an interior space and which has a plurality of cutting teeth, wherein at least one cutting edge, one tip of a cutting head and one cutting face are provided on each cutting tooth, wherein the cutting faces of all cutting teeth are arranged rotationally symmetrical with respect to the first rotation axis at a frontal plane or a frontal cone surface of the inside skiving ring, and wherein the tips of the cutting heads of all cutting teeth point into the interior space, i.e., in the direction of the first rotation axis.

According to the invention, the relative movement sequences (called relative movements) between the work piece and the inside skiving ring are predetermined and performed such that material is taken off continuously at the outside of the work piece until the teeth or the other outer periodic structures are formed completely.

Preferably, the cutting faces are arranged rotationally symmetric with respect to the rotation axis of the inside skiving ring on a frontal cone surface, which may tilt with respect to a frontal plane.

According to the invention, a radial movement may be superimposed on the relative feed movement of the inside skiving ring, so as to influence, e.g., the crowning of the teeth according to the technical teaching of the German patent application DE 3915976 A1.

The inside skiving may be applied on an untoothed work piece, preferably in a soft machining.

The inside skiving may be applied at a pre-toothed work piece, preferably after a soft machining.

During the inside skiving, the rotating inside skiving ring performs an axial feed movement with respect to the rotating work piece in the direction of the second rotation axis, wherein this axial feed movement runs in the same direction or in the opposite direction relative to the cutting direction.

According to the invention, the tooth gaps can be brought directly to the full depth and do not have to be generated in this case by a multiple cutting strategy.

The inside skiving can be applied in the framework of a multi-cut skiving method. According to the invention, radial movements may be superimposed to the axial movements, so as to implement a multiple cutting strategy or so as to generate incoming or outgoing tooth grooves according to the technical teaching of the international patent application WO 2010/060733 A1.

According to the invention, the tool life of the inside skiving rings serving as the skiving tool is significantly improved, because more cutting teeth can be accommodated due to the special constructional shape of the inside skiving rings. In particular, more cutting plates or cutter bars can be accommodated on the inside skiving ring than previously under the described limitations of real machining machines for skiving tools.

In the inside skiving, the rotation axis of the inside skiving ring is set skew with respect to the rotation axis of the work piece, i.e., the intersection angle of axes Σ is always different from zero.

In addition, the inside skiving ring can be inclined toward the work piece or inclined away from the work piece during the skiving, as described, for example, in a parallel application of the present applicant, which has been filed in the European patent office on 26 May 2011 under the application number EP 11167703.5.

The inside skiving concerns a continuous chip removing method.

Preferably, in all embodiments, a disc-like inside skiving ring is applied, which differs significantly from other skiving tools.

According to the invention, the inside skiving ring has a disc-like tool section, which has cutting heads, which are formed in the shape of cutting teeth, which project straight or obliquely into the interior space in the direction of the rotation axis of the inside skiving ring.

The disk-like inside skiving rings according to the invention may be implemented as so-called bulk tools, i.e., tools are concerned which are carried out essentially as one piece. For the bulk tools, the cutting teeth are an integral component of the tool. In all embodiments of the invention, cutter head inside skiving rings (herein called cutter bar inside skiving rings) are particularly preferred, which have an annular (mostly disc-like) cutter head base body, which is equipped with cutter inserts, preferably in the form of cutter bars, such that the cutting teeth project straight or obliquely into the interior space in the direction of the rotation axis of the inside skiving ring. Embodiments of the invention are also possible, which are designed as cutting plate tools, which have an annular (mostly disc-like) cutter head base body, which is equipped with cutting plates, the cutting teeth of which project straight or obliquely into the interior space in the direction of the rotation axis of the inside skiving ring.

Compared to the conventional skiving, the invention offers a number of advantages, which are listed in summary in the following:
longer tool life of the tools;
lower cost per tool;
reduced tool failure;
reduced space requirement (distance between axes and/or dimension of the work space) for the machining section of the machine;
improved cost effectiveness; and
improved chip forming conditions due to a longer engagement of each cutting tooth due to the higher contact ratio.

The method according to the invention may be performed in relation with both dry and wet machining.

The method according to the invention may be utilized for the soft and/or hard machining.

### BRIEF DESCRIPTION OF THE DRAWINGS

Further details and advantages of the invention are described in the following on the basis of embodiment examples and with reference to the drawings. In all schematic drawings, for reasons of simplicity of the representation, the work piece and the skiving tool are reduced to the situation on the rolling circle (e.g., rolling cylinder). However, the represented conditions hold for the entire toothing having one tooth height.

FIG. 1 shows a schematic representation of a shaping wheel having a cylindrical outer contour in engagement with a work piece having an outer toothing during gear shaping;

FIG. 2A shows a schematic representation of a straight-toothed skiving wheel having a cylindrical outer contour in engagement with a work piece having an outer toothing during skiving;

FIG. 2B shows a schematic representation of a helically toothed skiving wheel having a conical outer contour in engagement with a work piece having an outer toothing during skiving;

FIG. 3A shows a schematic projection of an intersection of axes (projection of contact plane) of a conical skiving tool during skiving of a work piece having an outer toothing, wherein an intersection angle of the axes is predetermined in the conventional manner;

FIG. 3B shows a schematic side projection of an intersection of axes (side projection of contact plane) of the conical skiving tool and the work piece of FIG. 3A;

FIG. 4A shows a schematic projection of the intersection of the axes (contact plane projection) of a conical (outer) skiving tool during the skiving of an outer-toothed work piece, wherein an intersection angle of axes of 25 degrees is prescribed;

FIG. 4B shows a schematic side projection of the intersection of the axes (contact plane side projection) of the conical (outer) skiving tool and work piece of FIG. 4A;

FIG. 5A shows a schematic back side projection of the intersection of the axes (contact plane projection) of a conical inside skiving ring according to the invention during the skiving of an outer-toothed work piece, wherein an intersection angle of the axes of 25 degrees is prescribed;

FIG. 5B shows a schematic contact plane side projection of the conical inside skiving ring a work piece of FIG. 5A;

FIG. 6 shows a schematic view of an inside skiving ring with respect to the so-called contact plane with a significantly negative tilt angle δ=−25 degrees;

FIG. 7 shows a schematic view of an inside skiving ring with respect to the so-called contact plane with a significantly positive tilt angle δ=25 degrees;

FIG. 8 shows a schematic view of a cylindrical inside skiving ring during the skiving of a work piece, wherein an effective intersection angle of the axes of 30 degrees is prescribed and the inside skiving ring is inclined away from the work piece with a tilt angle of 15 degrees;

FIG. 9 shows a schematic view of a conical inside skiving ring during the skiving of a work piece, wherein an effective intersection angle of the axes of 30 degrees is prescribed and the inside skiving ring is inclined toward the work piece with a tilt angle of −20 degrees;

FIG. 10 shows a schematic view of an inside skiving ring and the rolling circle of a work piece, wherein only three cutter bars of the inside skiving ring are shown here;

FIG. 11A shows a schematic view of a conical inside skiving ring, which can be employed in relation with the invention, wherein the inside skiving ring is equipped with cutter bars, the cutting faces of which lie on a front-side cone surface (in reality, the inside skiving ring has a greater diameter than shown);

FIG. 11B shows a schematic view of the inside skiving ring of FIG. 11A together with an outer-toothed cylindrical work piece, wherein a tilt angle δ of −20 degrees is prescribed;

FIG. 12A shows a schematic view of a conical side peeling ring which can be applied in relation with the invention, wherein the inside skiving ring is equipped with cutter bars, the cutting faces of which lie on a front-side cone surface (in reality, the inside skiving ring has a greater diameter than shown);

FIG. 12B shows a schematic view of the inside skiving ring of FIG. 12A together with an outer-toothed cylindrical work piece, wherein a tilt angle δ of 20 degrees is prescribed;

FIG. 13 shows a schematic perspective view of a portion of an inside skiving ring during the skiving of a straight-toothed work piece obliquely from below, wherein only some cutter bars of the inside skiving ring are shown and the annular base body of the inside skiving ring has been blinded out;

FIG. 14 shows a schematic perspective view of a portion of an inside skiving ring (bulk tool) during the skiving of a straight-toothed work piece obliquely from above, wherein the inside skiving ring and the work piece are respectively shown in section;

FIG. 15A shows a perspective view of a machine according to the invention; comprising an inside skiving ring during the toothing of an outer-toothed work piece; and

FIG. 15B shows details of a preferred shape of the clamping of the inside skiving ring on a tool spindle in a machine according to the invention of FIG. 15A.

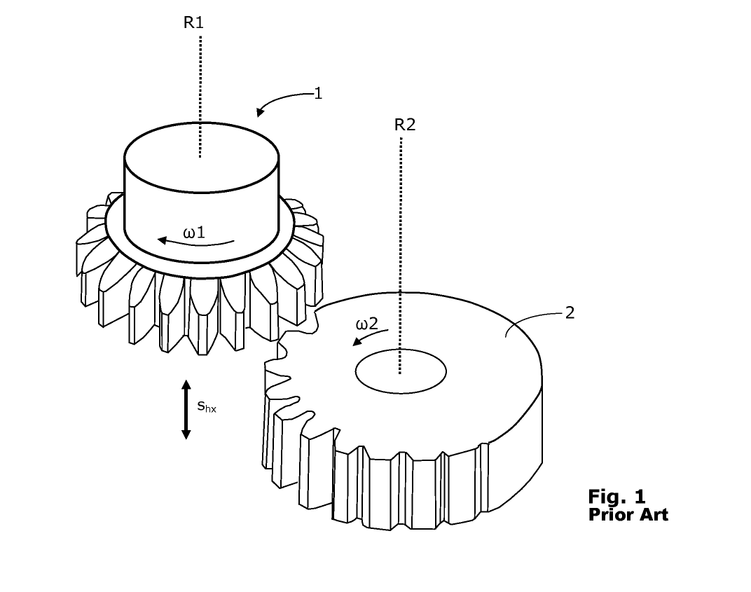

### DETAILED DESCRIPTION OF EMBODIMENTS OF THE INVENTION

In relation with the present description, terms are used which also find use in relevant publications and patents. It is noted however, that the use of these terms shall merely serve a better comprehension. The inventive idea and the scope of the patent claims shall not be limited in their interpretation by the specific selection of the terms. The invention can be transferred without further ado to other systems of terminology and/or technical areas. In other technical areas, the terms are to be employed analogously.

Rotational-symmetric periodic outer structures are, for example, gear wheels having an outer toothing. However, for example, also brake discs, clutch or gear transmission elements, and so on may be concerned. The inside skiving tools are particularly suitable for the manufacturing of pinion shafts, worms, ring gears, toothed wheel pumps, ring joint hubs (ring joints are employed, for example, in the motor vehicle sector for transmitting the force from a differential gear to a vehicle wheel), spline shaft joints, belt pulleys, and so on. Herein, the periodic structures are also called periodically repeating structures.

In the following, mention is made primarily of gear wheels, teeth and tooth gaps. However, as mentioned above, the invention can, also be transferred to other construction parts with other periodic outer structures. In this case, these other construction parts do not concern tooth gaps, but, for example, grooves or channels.

For reasons of simplicity, all drawings are reduced to the situation at the rolling circles e.g., rolling surfaces. Therefore, the corresponding rolling bodies are shown in the drawings.

The skiving method according to the invention, which is herein also called the inside skiving method, is for the skiving of a work piece 50 having a rotationally symmetric, periodical, outer structure by applying an inside skiving ring 100. The inside skiving ring 100 that is applied herein has an annular base body 112, which can be recognized clearly, e.g., in FIG. 5B.

The inside skiving ring 100 is an inside tool, which spans a (mostly circular) interior space 113. The inside skiving ring 100 has a plurality of cutter heads 111 (not shown in FIGS. 5A and 5B), on which the cutting edges for the chipping machining of the work piece 50 are provided. Each cutting head 111 has a cutting face (referenced with the reference numeral 121 in the FIGS. 11A, 11B, 12A, 12B, 13, 14), which is arranged rotationally symmetric with respect to the rotation axis R1 on a front-side plane (called front plane SE) or on a front-side cone surface KE (individually tilted with respect to the front plane SE or cone plane KE by a step angle as needed). In FIG. 10, the front plane SE is defined by two concentric circles K1 and K2 (the circle K2 may correspond to the rolling circle W1 of the tool 100). The two concentric circles K1 and K2 may represent, e.g., the outer diameter DA and the inner diameter DI of the annular base body 112 of the inside skiving ring 100.

The cutting faces 121 are arranged rotationally symmetric with respect to the rotation axis R1 of the tool 100 on a front-side cone surface, which may be tilted with respect to a front plane.

The cutting faces 121 may be formed as plane surfaces or as slightly curved surfaces on the cutter heads 111. The cutting faces 121 may also be slightly convex.

Generally (i.e., for all embodiments) it holds that in the skiving, the cutting direction, respectively, the cutting speed vector \vec{v}_{c} embraces an angle different from 90 degrees with respect to the rotation axis R1 of the tool 100. The acute one of the two embraced angles is preferably smaller than or equal to 60 degrees, particularly preferably smaller than or equal to 45 degrees.

Due to the complex kinematics, the cutting speed vector of a point of the cutting edge, which results during the chip cutting at the cutting edges, possibly deviates from the cutting speed vector \vec{v}_{c} at the calculation point AP during the skiving. However, this deviation is not large so that also for these effective cutting speed vectors the following statements may be made (this statement holds for all embodiments of the invention):
The effective cutting speed vector embraces an angle different from 90 degrees with the rotation axis R1 of the tool 100.
The acute one of the two embraced angles is preferably less than or equal to approximately 60 degrees, particularly preferably less or equal to approximately 45 degrees.

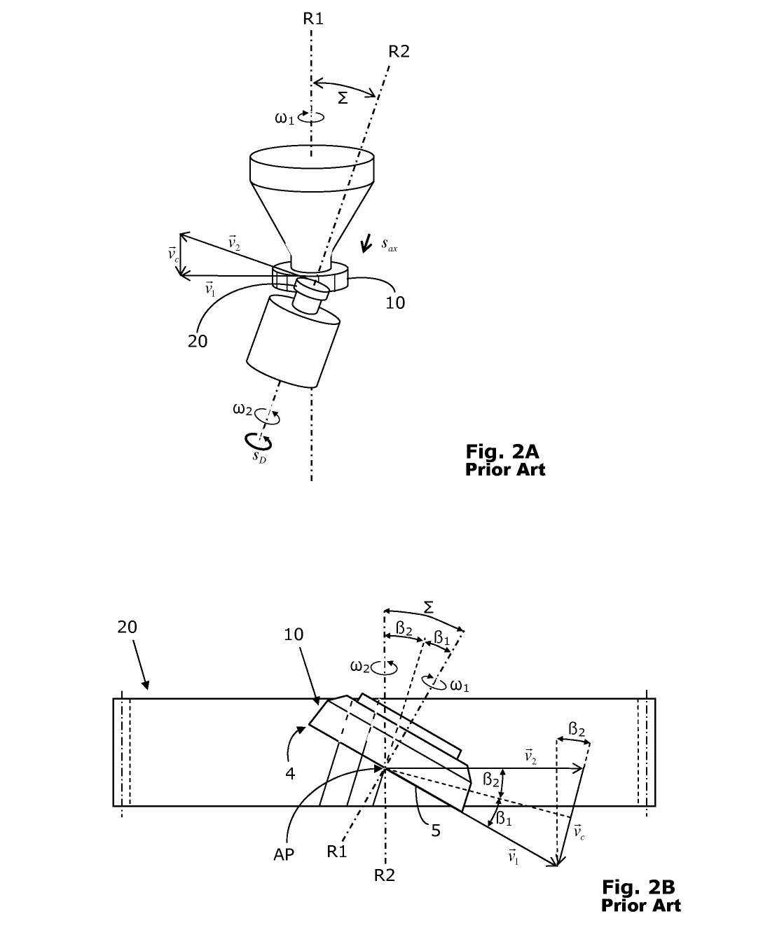

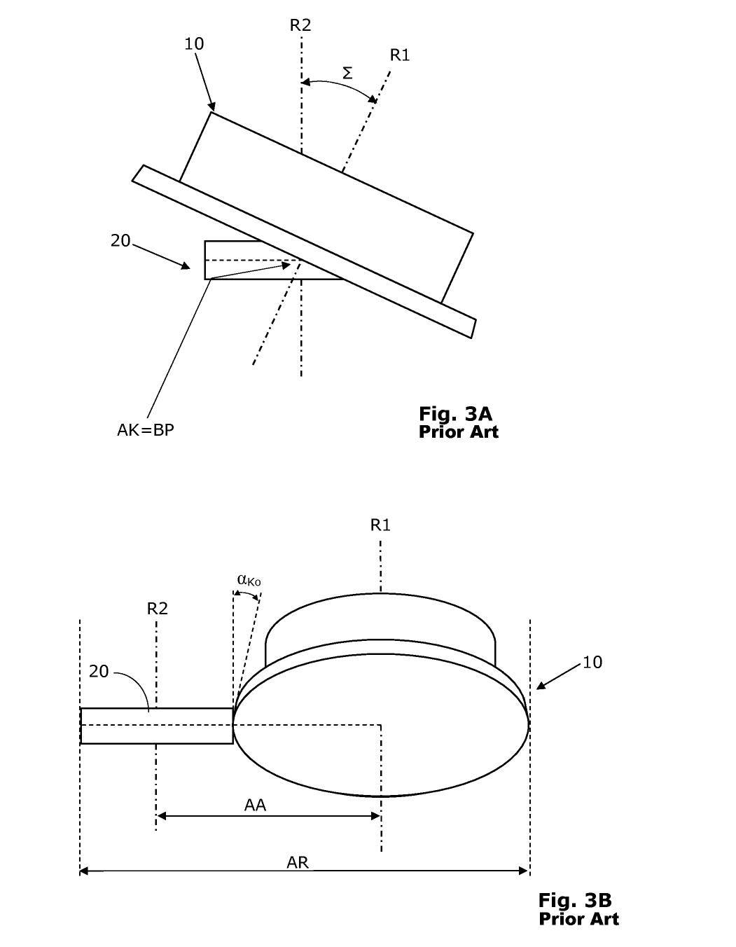

In FIGS. 5A and 5B, an exemplifying inside skiving ring 100 is shown schematic form, which has a conical inner mantle surface. The conicality of the inner mantle surface (called cone surface 114) of the inside skiving ring 100 can be recognized in FIG. 5A. The conical shape of the inner mantle surface serves to provide a constructive relief angle, as is shown in FIG. 3B. A conical inside skiving ring 100 thus has a conical inner mantle surface.

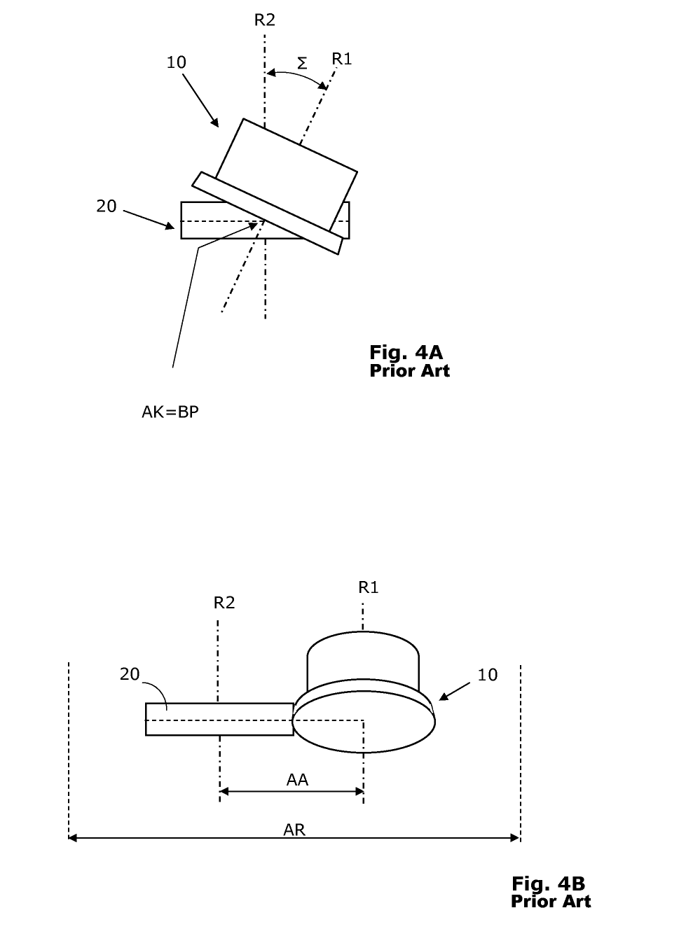

The example of FIGS. 5A and 5B has been chosen deliberately such that the skiving of the same outer toothing as in FIGS. 3A, 3B and 4A, 4B is concerned. Again, it shall be worked with an intersection angle of axes Σ of 25 degrees. The rolling circle diameter of the work piece 50 amounts again to 200 mm here. The work space AR in the direction of the axis distance of the machining machine to be employed amounts to 600 mm. The travelling distances of the machining machine to be employed allows for a maximum distance AA between axes of 200 mm.

In such an exemplifying embodiment, a conical inside skiving ring 100 may comprise in total 56 cutting heads 111 which point inwardly and which are formed in the shape of cutting teeth, for a ring strength RS of 50 mm with a rolling circle diameter that is as large as possible of approximately 494 mm. The distance AA between axes amounts to only approximately 147 mm here.

In comparison to, for example, the FIGS. 3A, 3B, a tool life that is greater by more than 27% can be expected, when applying the inside skiving ring 100 having 56 cutting teeth 111 pointing inwardly. In comparison to, for example, the FIGS. 4A, 4B, a tool life that is greater by approximately 155% can be expected.

A further advantage of the inside skiving rings 100 according to the invention is the higher overlap during the engagement of the cutting teeth 111. The resulting longer engagement distance leads to better chip-forming conditions.

In all embodiments of the invention, the two rotation axes R1 and R2 are skew with respect to each other. The intersection angle of axes Σ is always different from zero.

Preferably, during the inside skiving, the inside skiving rings 100 according to the invention may be inclined towards the work piece 50 or inclined away from the work piece 50. The inclination of the tool 100 is optional. Generally it serves to avoid collisions. In addition, however, it provides the following advantages:
The inclination away enables cylindrical inside skiving wheels 100, which enable the same cutting edge profiles during the regrinding as are known from cylindrical (outer) skiving wheels.
The inclination towards enables regrindable cutter bars which are arranged flatly.

The tilt angle δ is defined on the basis of the FIGS. 6 and 7.

FIG. 6 shows a schematic view of an inside skiving ring 100 with respect to the so-called contact plane BE. The representation of the tilting towards (δ<0) with respect to the contact plane BE according to FIG. 6 is particularly demonstrative. The rotation axis R1 of the tool intersects the contact plane BE in the cutting edge half space (the cutting edge half space is defined below).

FIG. 7 shows a schematic view of an inside skiving ring 100 with respect to the so-called contact plane BE. The representation of the inclination away (δ>0) with respect to the contact plane BE according to FIG. 7 is particularly demonstrative. The rotation axis R1 of the tool intersects the contact plane BE in the chip half space (the chip half space is defined below).

If the tilt angle δ is zero, the rotation axis R1 of the inside skiving ring 100 runs parallel at a distance to the contact plane BE, i.e., the rotation axis R1 does not intersect the contact plane BE in an intersection point SP.

Preferably, the tilt angle δ is in the range between −30 degrees and +30 degrees.

In the following, several examples for inclined inside skiving rings 100 during the skiving are described.

In FIG. 8, a cylindrical inside skiving ring 100 (called cylinder ring) is shown, which is tilted away. The effective intersection angle of axes Σ_{eff} amounts to 30 degrees, the tilt angle δ amounts to 15 degrees and the kinematically produced relief angle amounts to approximately 15 degrees at the cutter head and to approximately 7.5 degrees at the flanks. The cylindrical inside skiving ring 100 has a virtual cylindrical inner mantle surface 114. The joint plumb GL is located above the work piece 50 in the view shown. Stated more precisely, the joint plumb GL is located in the cutting edge half space of the inside skiving ring 100.

Cylindrical as well as conical inside skiving rings 100 are suitable as skiving tools 100, which are inclined away from the work piece 50, whereby a collision of the inside skiving ring 100 with the work piece 50 does not result due to the inclination away.

In FIG. 9, a conical inside skiving ring 100 is shown, which is inclined towards the work piece 50. The effective intersection angle of axes Σ_{eff} amounts to 30 degrees, the tilt angle δ amounts to −20 degrees. The conical inside skiving ring 100 has a virtual conical inner mantle surface 114. Only conical inside skiving rings are suitable as skiving tools 100 tilted towards the work piece 50, because collisions would result otherwise. The joint plumb GL is located below the work piece 50 in the view shown and is therefore not visible. To be more precisely, the joint plumb GL is located in the chip half space of the inside skiving ring 100.

According to the invention, each cutter head 111 respectively each cutting tooth has a cutting head tip 122, which projects into the interior space 113 and points in the direction of the first rotation axis R1. This aspect of the inside skiving rings 100 according to the invention can be recognized, e.g., in FIG. 10, where only three of a greater number of cutter bars 120 are shown for reasons of simplicity. In the example shown, the longitudinal axes LA1, LA2, LA3 of all the cutter bars 120 intersect the rotation axis R1 in a common point. However, it is also conceivable, that the longitudinal axes LA1, LA2, LA3 of all cutter bars 120 point skew in the direction of the first rotation axis R1, but do not contact the rotation axis R1. Similarly, the longitudinal axes LA1, LA2, LA3 do not need to lie in a plane.

This statement holds also for bulk tools (see e.g., FIG. 14) which are implemented with integrated cutter heads 111. Also here, the longitudinal axes (in FIG. 14, only one longitudinal axis LA is shown) run in the direction of the rotation axis R1. They may intersect the rotation axis R1 or run past the rotation axis. They do not need to lie in one plane.

In all embodiments, the cutter head 111 projects at least for a portion out of the material of the base body 112 and into the interior space 113.

In FIG. 11A, a schematic view of a conical inside skiving ring 100 is shown, which can be utilized in relation with the invention for skiving. As shown in the schematic representation of FIG. 11A, the skiving tool 100 concerns a tool with an annular base body 112 which is equipped with cutter inserts, preferably in the form of cutter bars 120. The inside skiving ring 100 is connected movement-specifically by means of a tool spindle (that is not shown here) to a machine 200. Details of a preferred form of the clamping of the inside skiving ring 100 on a tool spindle 170 can be taken from the FIG. 15B. Here, the cutting faces 121 of the cutter bars 120 are located on a front-side cone surface KE, the rotation axis of which coincides with the rotation axis R1 of the inside skiving ring 100. The work piece 50 (not shown here) is located at least partly in the interior space 113 of the inside skiving ring 100 during the skiving. In reality, the inner diameter DI and the outer diameter DA of the inside skiving ring 100 are significantly larger than shown in FIG. 11A. The total inner diameter of the inside skiving ring 100 together with the cutting teeth 111 and other projecting elements is considered as the minimum inner diameter.

Preferably, in all embodiments of the invention, the minimum inner diameter of the inside skiving ring 100 is at least 1.5 times as large as the outer diameter DWA of the work piece 50 to be machined. Inside skiving rings 100, the minimum diameter of which are at least two times as large as the outer diameter DWA of the work piece 50 to be machined, are particularly preferred. In addition to the prerequisite of a suitable inner diameter DI for a collision-free reception of the work piece 50 it should be observed during the definition of the intersection angle of axes Σ and the tilt angle δ (if this is different from zero), that a collision of the work piece 50 with the tool 100 does not result. In addition to the prescription of the inner diameter DI, respectively, the minimum inner diameter, the intersection angle of axes Σ and the tilt angle δ (if this is different from zero), the inner mantle surface 114 may have a conicity (as shown e.g., in FIG. 11A), so as to thus avoid collisions. An inside skiving ring 100 according to FIG. 11A is particularly suitable for the inclination toward the work piece 50 (i.e., 6 is less than 0 degrees).

FIG. 11B shows a schematic view of the inside skiving ring 100 of FIG. 11A together with a cylindrical work piece 50, wherein a tilt angle δ of −20 degrees is prescribed. The inside skiving ring 100 has an inner mantle surface 114 as its inside collision contour, which has been chosen such that a collision of the inside skiving ring 100 with the work piece 50 does not result despite the significant inclination of the cylindrical work piece 50 with δ=−20 degrees towards. In FIG. 11B, the scale of the inside skiving ring 100 and of the work piece 50 corresponds better to the reality than in FIG. 11A.

In FIG. 12A, a schematic view of a conical inside skiving ring 100 is shown, which may be utilized in relation with the invention for skiving. As shown in the schematic representation in FIG. 12A, the skiving tool 100 concerns a tool having an annular base body 112 which is equipped with cutter inserts, preferably in the form of cutter bars 120. The inside skiving ring 100 is fixed to a machine 200 movement-specifically by means of a tool spindle that is not shown here. The cutting faces 121 of the cutter bars 120 are located on a front-side cone surface KE, the rotation axis of which coincides with the rotation axis R1 of the inside skiving ring 100. The work piece 50 (not shown here) is located at least partly in the interior space 113 of the inside skiving ring 100 during the skiving. In reality, the inner diameter DI and outer diameter DA of the inside skiving ring 100 are significantly larger than those shown in FIG. 12A.

The tool 100 of FIG. 12A again has an inner mantle surface 114, which has a conicity. An inside skiving ring 100 according to FIG. 12A is particularly suitable for inclining away from the work piece 50 (i.e., δ is greater than 0 degrees).

FIG. 12B shows a schematic view of the inside skiving ring 100 of FIG. 12A together with a cylindrical work piece 50, wherein a tilt angle δ of 20 degrees is prescribed. The inside skiving ring 100 has an inner mantle surface 114 as its inside collision contour, which has been chosen such that no collision of the inside skiving ring 100 with the work piece 50 results, whereby the cutter bars are held optimally however, i.e., they project as little as possible from the base body 112. It should be noted here, that the inner mantle surface 114 of the tool 100 of FIGS. 11A and 11B proceeds conically inversely to the tool 100 of FIGS. 12A and 12B.

For the inclination towards the work piece 50, the inside skiving ring 100 is preferably formed conically in order to avoid collisions. For the inclination away from the work piece 50, the inside skiving ring does not need to be formed conically. In this case, it may, e.g., also be formed cylindrically. In FIGS. 12A and 12B, the inside skiving ring 100 is not formed conically for avoiding collisions, but sufficient space is available by the inclination of the inside skiving ring 100 away from the work piece 50 so as to thus better hold/embrace the cutter bars 120.

FIG. 13 shows a schematic perspective view of a portion of an inside skiving ring 100 during the inside skiving of a straight-toothed work piece 50, whereby only a few cutter bars 120 of the inside skiving ring 100 are shown. The teeth 51 respectively the tooth gaps 52 between the teeth 51 are already almost finalized on the straight-toothed work piece 50. The annular base body 112 of the inside skiving ring 100 has been blinded off. On the basis of FIG. 13, it can be recognized well that the shafts (shown with a rectangular cross-section here) of the cutter bars 120 can be arranged without problems and collision-free in an annular base body 112. In FIG. 13, the two circles K1 and K2 are indicated by circle segments. The circles K1 and K2 define the front plane SE, as mentioned already in relation with FIG. 10. In FIG. 13, on one of the cutter bars 120, the cutting tooth 111, the cutting face 121 and the longitudinal axis LA are referenced. The cutting faces 121 of the cutting teeth 111 are slightly inclined with respect to the front plane SE in the example shown.

FIG. 14 shows a schematic perspective view oblique from above of a portion of an inside skiving ring 100, which is formed as a bulk tool here, during the inside skiving of a spur toothed work piece 50. The inside skiving ring 100 and the work piece 50 are shown here by way of a section. The teeth 51, respectively the tooth gaps 52 between the teeth 51 are already almost finalized on the straight-toothed work piece 50. The cutting teeth 111 are an integral component of the annular base body 112 of the inside skiving ring 100 here. In FIG. 14, on one of the cutting teeth 111, the cutting face 121 and the longitudinal axis LA are referenced. The cutting faces 121 of the cutting teeth 111 are slightly inclined with respect to the front plane SE in the example shown.

On the basis of FIG. 13 and FIG. 14, it can be recognized that in the inside skiving according to the invention more than only one cutting tooth 111 always engages and cuts in a corresponding tooth gap 52 of the work piece 50, when all the cutting teeth 111 are formed on the inner mantle surface of the inside skiving ring 100.

The inside skiving method comprises the following steps:
rotating the inside skiving ring 100 about the first rotation axis R1,
coupledly rotating the work piece 50 about the second rotation axis R2, and
performing an axial feed movement VB of the inside skiving ring 100 with respect to the work piece 50 in a direction parallel to the second rotation axis R2.

During the skiving, the two rotation axes R1, R2 are set skew relative to each other with an intersection angle of axes Σ.

The inside skiving is characterized in that the inside skiving ring 100 spans an interior space 113 and comprises a plurality of cutting teeth 111. At least one cutting edge, one cutting head tip 122 and one cutting face 121 are provided on each cutting tooth 111. The cutting faces 121 of all the cutting teeth 111 are arranged rotationally symmetric with respect to the first rotation axis R1 on a front plane SE or a front-side cone surface KE of the inside skiving ring 100. The cutting teeth 111 project into the interior space 113 and point in the direction of the first rotation axis R1.

According to the invention, a feed motion opposite to the cutting direction or an aligned feed motion is generated by an according axial feed VB of the inside skiving ring 100 relative to the work piece 50. The direction of the feed motion VB is indicated in the FIGS. 13 and 14. A machine 200, as shown by way of example in FIG. 15A, generates the suitable movements by means of a CNC-control 201.

In all embodiments, the effective intersection angle of axes Σ_{eff} is preferably in the following range: −60°≦Σ_{eff}≦60°, Σ_{eff}≠0°. Effective intersection angles of the axes Σ_{eff} between, in absolute value, 5 and 45 degrees are particularly preferred.

A CNC-controlled superposition of the coupled rotations of the inside skiving ring 100 about the first rotation axis R1 and the work piece 50 about the second rotation axis R2, and the feed movements VB of the skiving tool 100 relative to the work piece 50 result in a chip-cutting skiving movement of the cutting teeth 111 of the inside skiving ring 100.

At the beginning of the inside skiving, the inside skiving ring 100 can be plunged radially from the outside to the inside into the material of the work piece 50, or the inside skiving ring 100 can be plunged axially, i.e., coming from the front side 53 of the work piece 50. In the FIGS. 5A and 5B, by way of example, the upper front side is referenced with the reference numeral 53 and the lower front side with the reference numeral 54.

In the following paragraphs, further explanations concerning the inside skiving according to the invention are provided.

Basically, also in the inside skiving, the relative movement between the inside skiving ring 100 and the work piece 50 corresponds to a helical gear, also called generation helical type gear transmission. The helical gear concerns a spatial transmission gear.

The basic design of the inside skiving process therefore occurs at a so-called calculation point AP (see e.g., FIG. 2B) as in the design of transmission gears. The term basic design is understood herein to refer to the definition of the spatial arrangement and movement of the inside skiving ring 100 with respect to the work piece 50 (kinematic) as well as the definition of the geometrical basic quantities (herein called basic tool geometry) of the inside skiving ring 100, such as the rolling circle diameter, conicity and helix angle.

The geometrical and kinematic engagement conditions at the calculation point AP are designed as optimal as possible. The engagement conditions change with increasing distance from the calculation point AP. In this relation, the skiving represents a very complex process, in which the engagement conditions vary also during the movement of the cutting edge. However, the varying engagement conditions can be influenced selectively via the engagement conditions at the calculation point AP.

Thus, the correct design of the engagement conditions at the calculation point AP has a considerable importance in the design of skiving processes.

Terms concerning the arrangement of axes:

There are several terms, which are required for the definition of the arrangement of axes. These terms are described in Table 1 below.

TABLE 1

| | |
|---|---|
| joint plumb, base | Skiving processes are characterized by rotation axes R2 and R1 of the |
| points of joint | work piece 50 and the skiving tool 100, which intersect each other in |
| plumb, joint | space. For the two rotation axes R2 and R1 intersecting each other, the |
| plumb vector | joint plumb GL can be indicated uniquely. |
| | The base point of the joint plumb on the rotation axis R2 of the work |
| | piece 50 shall be GLF2 (see e.g., FIG. 8). The base point of the joint plumb |
| | on the rotation axis R1 of the skiving tool 100 shall be GLF1. |
| | The joint plumb vector GLV (see e.g., FIG. 5B) shall be the connection |
| | vector from GLF1 to GLF2. |
| projection of | The view of the work piece 50 and the skiving tool 100 along the joint |
| intersection of | plumb GL in the direction of the joint plumb vector GLV is called |
| axes, intersection | projection of intersection of axes (see e.g., FIG. 5A). |
| point of axes | In the projection of intersection of axes, the projected rotation axes R1 |
| | and R2 intersect each other in the intersection point of axes AK, which |
| | corresponds to the joint plumb L that is reduced in the projection to a |
| | point. |
| intersection angle | The intersection angle of axes Σ is the angle, the absolute value of which |
| of axes | is smaller, and which is embraced by the two rotation axes R1 and R2. It |
| | becomes visible in the projection of intersection of axes (see e.g., FIG. |
| | 5A). The following holds: −90° < Σ < 90°, Σ ≠ 0°. |
| | The intersection angle of axes Σ carries a sign. The sign is defined in the |
| | projection of intersection of axes as follows without limiting the |
| | generality: For outer toothings, the intersection angle of axes Σ is positive, |
| | if the projected rotation axis R1 is rotated about the intersection point of |
| | axes AK mathematically positive by \|Σ\| with respect to the projected |
| | rotation axis. |
| Center distance | The center distance between axes A corresponds to the length of the joint |
| between axes | plumb vector GLV (see e.g., FIG. 5B). It describes the smallest distance |
| | between the rotation axes R1 and R2. |

Terms concerning the contact between the skiving tool and the work piece:

There are several terms, which are necessary for the description of the contact between the skiving tool and the work piece. These terms are described in Table 2 below.

TABLE 2

| | |
|---|---|
| rolling circles | The rolling circles of the work piece 50 and the skiving |
| | tool 100 contact each other in the calculation point AP, |
| | which is therefore also called contact point BP. The |
| | rolling circle W2 (see e.g., FIG. 5B) of the work piece |
| | 50 (also called work piece rolling circle) lies in a plane |
| | that is perpendicular to the rotation axis R2 of the |
| | work piece 50. The center of the rolling circle W2 |
| | lies on the rotation axis R2 of the work piece 50. |
| | The diameter of the rolling circle W2 of the work piece |
| | is d_{w2}. |
| | The rolling circle W1 (see e.g., FIG. 5B) of the skiving |
| | tool 100 (also called tool rolling circle) lies in a plane |
| | that is perpendicular to the rotation axis R1 of the |
| | skiving tool. The center of the rolling circle W1 lies |
| | on the rotation axis R1 of the skiving tool 100. The |
| | diameter of the rolling circle W1 of the tool is d_{w1}. |
| | For an inside skiving ring, d_{w1} is negative. |
| reference | The reference plane of the work piece is the plane, in |
| planes | which the rolling circle W2 of the work piece lies. |
| | The reference plane of the tool is the plane, in |
| | which the rolling circle W1 of the tool lies. |
| chip half | The reference plane of the tool divides the three |
| space, cutter | dimensional space into halves. The chip half space |
| half space | shall be the half space, into which the perpendicular |
| | to the cutting face, which points outwardly of the |
| | cutting edge material of the skiving tool 100, the |
| | cutter bars 120 or cutting plates, points into. The other |
| | half shall be called cutter half space. The cutting edges |
| | 111 of the skiving tool 100 thus extend essentially in |
| | the cutter half space, however they can also extend into |
| | the chip half space, wherein the cutting faces 121 are |
| | turned toward the chip half space. |
| velocity | In the calculation point AP, the velocity vector \vec{v}₂ of the |
| vectors | corresponding point of the work piece |
| | can be indicated, which vector results from the rotation |
| | of the work piece about R2. It lies in the reference plane |
| | of the work piece, tangentially to the rolling circle W2 |
| | of the work piece. The absolute value is v₂ = \|π · d_{w2} · n₂\| |
| | with a rotation frequency n₂ of the work piece |
| | carrying a sign. |
| | In the calculation point, also the velocity vector \vec{v}₁ |
| | of the related point of the tool can be indicated, which |
| | vector results from the rotation of the tool about R1. It |
| | lies in the reference plane of the tool, tangentially to the |
| | rolling circle W1 of the tool. The absolute value is |
| | v₁ = \|π · d_{w1} · n₁\| |
| | with the rotational frequency n₁ of the tool |
| | carrying a sign. |
| contact | Starting from the calculation point AP, the plumb |
| radius | onto the rotation axis R2 of the work piece 50 can |
| vectors | be drawn. The related orthogonal projection LF2 of the |
| | plumb corresponds to the intersection point between the |
| | reference plane of the work piece and the rotation axis |
| | R2 of the work piece (see e.g., FIG. 14B). The contact |
| | radius vector \vec{r}₂ of the work piece |
| | 50, 60, 70 is, for inner toothings, the vector from the |
| | orthogonal projection of the plumb LF2 to the calculation |
| | point AP, and for outer toothings the vector from the |
| | calculation point AP to the orthogonal projection of |
| | the plumb LF2. Its length is \|d_{w2}\|/2. |
| | Starting from the calculation point AP, the plumb onto |
| | the rotation axis R1 of the skiving tool 100 can be drawn. |
| | The related orthogonal projection of the plumb LF1 |
| | (see e.g., FIG. 6) corresponds to the intersection point |
| | between the reference plane of the tool and the rotation |
| | axis R1 of the tool. The vector from the orthogonal |
| | projection of the plumb LF1 to the calculation point |
| | AP is called contact radius vector \vec{r}₁ of the |
| | tool 100. Its length is d_{w1}/2. |
| contact plane | The two velocity vectors \vec{v}₂ and \vec{v}₁ |
| BE | span the so-called contact plane BE (see e.g., FIGS. 6 |
| | and 7). The rolling circles W2 and W1 of the work |
| | piece 50 and the skiving tool 100 contact each other |
| | in this contact plane BE, and namely in the calculation |
| | point AP. In addition, also the theoretical pitch surface |
| | of the toothing of the work piece 50 and the rolling |
| | circle W1 of the skiving tool 100 contact each other |
| | in this contact plane BE according to the design. |
| | Stated more precisely, the contact plane BE is |
| | tangentially to the mentioned pitch surface of the |
| | toothing of the work piece 50, and namely in the |
| | calculation point AP. |
| pitch surface, | The pitch surface of a toothing is also called reference |
| reference | pitch surface. It goes through the calculation point AP, |
| pitch | is rotationally symmetrical with respect to the rotation |
| surface | axis R2 of the work piece 50 and reflects a portion of |
| | the basic geometry of the toothing. The pitch circle |
| | (rolling circle) W2 is part of the pitch surface of the |
| | toothing of the work piece 50. |
| | For the cylindrical toothings which are described here |
| | in detail and are shown in the drawings, the pitch |
| | surface is a cylinder, for conical toothings a cone, |
| | for planar toothings a plane and for general spatial |
| | toothings as e.g., for hypoid wheels a hyperboloid. |
| | The explanations, which are given in the following |
| | in relation with cylindrical toothings, can be |
| | transferred accordingly to other toothings. |
| contact plane | The contact plane normal \vec{n} (see e.g., FIG. 6) shall |
| normal | be the normal vector of the contact plane BE |
| | which is anchored in the calculation point AP and |
| | which points into the toothing of the work piece 50, |
| | i.e., from the head section to the base section of the |
| | toothing. For outer toothings on the work piece 50 |
| | considered herein, the contact plane normal \vec{n} thus |
| | points toward the rotation axis R2 of the work |
| | piece 50. |
| | For cylindrical toothings, the contact plane normal |
| | points in the same direction as the contact radius |
| | vector \vec{r}₂ of the work piece 50, i.e., \vec{n} und \vec{r}₂ differ |
| | from each other only by their length. |
| projection of | The view of the work piece 50 and the skiving tool 100 |
| contact plane | in the direction of the contact radius vector \vec{r}₂ of |
| | the work piece 50 is called projection of contact plane. |
| | The projected rotation axes R1 and R2 intersect in the |
| | projection of contact plane (see e.g., FIG. 5A) in the |
| | calculation point AP resp. the contact point BP. |
| effective intersection angle of axes | $\begin{matrix}The effective intersection angle of axes {\sum }_{eff} is the \\ angle embraced by the two velocity vectors {\vec{v}}_{2} und \\ {\vec{v}}_{1} according to cos ( {\sum }_{eff} ) = \frac{{\vec{v}}_{2} \cdot {\vec{v}}_{1}}{\vert {\vec{v}}_{2} \vert \vert {\vec{v}}_{1} \vert} . According to\end{matrix}$ |
| | the invention the following holds: −90° < Σ_{eff} < 90°, |
| | wherein Σ_{eff} ≠ 0°. |
| | The effective intersection angle of axes Σ_{eff} carries a sign |
| | as the intersection angle of axes Σ. For the pairing of |
| | an outer toothing on the work piece 50 with an inside |
| | skiving ring 100, the sign is defined as follows without |
| | restriction of the generality: The effective intersection |
| | angle of axes Σ_{eff} is positive, if the velocity vectors \vec{v}₁ |
| | and \vec{v}₂ and the contact plane normal \vec{n} in this succession |
| | form a right-handed trihedron. For non-planar |
| | toothings on the work piece 50, the effective intersection |
| | angle of axes Σ_{eff} corresponds to the perpendicular |
| | projection of the intersection angle of axes Σ onto |
| | the contact plane BE, i.e., the intersection angle |
| | of axes Σ in the projection of contact plane. |
| tilt angle | The tilt angle δ describes the tilt (inclination) of the |
| | tool reference plane and thus the skiving tool |
| | 100 with respect to the contact plane BE (see |
| | FIGS. 6 and 7). It is the angle, which is in |
| | encompassed by the contact radius vector \vec{r}₁ of |
| | the skiving tool 100 and the contact plane |
| | normal \vec{n} according to |
| | $cos ( δ ) = \frac{\vec{n} \cdot {\vec{r}}_{1}}{\vert \vec{n} \vert \vert {\vec{r}}_{1} \vert} , wherein - 90 ° \leq δ \leq 90 ° ( see FIGS .$ |
| | 6 and 7). |
| | The tilt angle δ is identical to the intersection angle |
| | (the smaller one in terms of its absolute value) between |
| | the rotation axis R1 of the skiving tool 100 and the |
| | contact plane BE. |
| | The tilt angle δ is 0°, if the tool reference plane is |
| | perpendicular to the contact plane BE and thus the |
| | rotation axis R1 of the tool runs parallel to the contact |
| | plane BE. |
| | The tilt angle δ carries a sign. The tilt angle δ is positive, |
| | if the rotation axis R1 of the skiving tool 100 |
| | intersects the contact plane BE in the chip half |
| | space. The tilt angle δ is negative, if the rotation |
| | axis R1 of the skiving tool 100 intersects the contact |
| | plane BE in the cutter half space. |

Further Projections:

There are different further projections, which are employed for illustrating the invention. The further projections are explained in Table 3 below.

TABLE 3

| | |
|---|---|
| side projection of | The vector of the side projection of intersection of axes shall be |
| intersection of axes | the very vector, which is perpendicular to the joint plumb GL and |
| | to the rotation axis R2 of the work piece 50, and which embraces |
| | an acute angle with the velocity vector \vec{v}₂ of the contacting point |
| | of the work piece. Then, the view of the work piece 50 and of the |
| | skiving tool 100 in the direction of this vector of the side |
| | projection of intersection of axes is called side projection of |
| | intersection of axes. |
| | In the side projection of intersection of axes (see e.g., FIG. 5B), |
| | the projected rotation axes R1 and R2 run parallel to each other. |
| back side projection of | The view of the work piece 50 and the skiving tool 100 along the |
| intersection of axes | joint plumb GL in the reverse direction of the joint plumb vector |
| | GLV is called back side projection of intersection of axes. |
| side projection of contact | The view of the work piece 50 and of the skiving tool 100 in the |
| plane | direction of the velocity vector \vec{v}₂ of the contacting point of the |
| | work piece is called side projection of contact plane. |
| back side projection of | The view of the work piece 50 and of the skiving tool 100 in the |
| contact plane | reverse direction of the contact radius vector \vec{r}₂ of the work piece |
| | 50 is called back side projection of contact plane. |

For non-planar toothings, the following equation [1] establishes the relationship between the angles, which describe the spatial arrangement of the rotation axes R1 and R2, and is thus important for the conversion of the individual quantities:

cos(Σ)=cos(Σ_{eff})·cos(δ) [1]

The intersection angle of axes Σ is decomposed into the effective intersection angle of axes Σ_{eff} and the tilt angle δ, wherein the effective intersection angle of axes Σ_{eff} is the determining parameter for the generation of the relative cutting movement with the cutting speed vector \vec{v}_{c} between the rotating skiving tool 100 and the rotating work piece 50. For planar toothings, the effective intersection angle of axes Σ_{eff} and the tilt angle δ are well defined, however, the relation [1] does not hold.

According to the invention, a tilt angle δ can be prescribed, the absolute value of which is different from zero degrees, i.e., the tilt of the tool reference plane and thus of the skiving tool 100 with respect to the contact plane BE (which is spanned by the two speed vectors \vec{v}₂ and \vec{v}₁) is negative or positive.

According to the invention, in all embodiments, the inside skiving ring 100 has cutting edges and cutting faces, which are formed on cutting teeth 111, wherein the cutting teeth 111 project inwardly straight or obliquely, as can be recognized, e.g., in the FIGS. 10, 11A, 11B, 12A, 12B, 13 and 14. The cutting faces 121 of the cutting teeth 111 are formed substantially on the front plane SE of the inside skiving ring 100 or on a front side cone surface KE. The cutting faces 121 may, however, also be inclined (tilted) with respect to the front plane SE or the cone surface KE so as to align the cutting faces preferably normal to the cutting direction.

The inside skiving method can be applied on an untoothed work piece 50, preferably in the framework of a soft machining.

The inside skiving method may also be applied on a pre-toothed work piece 50, preferably after a soft machining. That is, the inside skiving method may also be applied for the hard or finishing machining. The according inside skiving method is also called inside hard skiving herein.

The inside skiving method may, however, also be applied in the framework of a multi-cut skiving method.

In the framework of such a multi-cut skiving method, several approaches are possible. The periodical structures on the work piece 50 may be generated either in two or more than two cutting phases. During a first cutting phase, e.g., a gap or groove can be cut to a depth of 50%. Then, the inside skiving ring 100 is set radially further inward in the direction of the rotation axis R2 of the work piece 50 to the full depth, and the gap or groove can then be cut to the full depth in the second cutting phase.

The rolling circle diameter d_{w1} of the inside skiving ring 100 is significantly greater than the rolling circle diameter d_{w2} of the work piece 50 in all embodiments of the invention. Preferably, the rolling circle diameter d_{w2} of the work piece 50 amounts to less than 60% of the rolling circle diameter d_{w1} of the inside skiving tool 100.

Preferably, the longitudinal axes LA1, LA2, LA3 of all the cutter bars 120 in all inside skiving rings 100 according to the invention that are formed as cutter head tools point inwardly in the direction of the rotation axis R1, as shown in FIG. 10 on the basis of three cutter bars 120. This statement holds analogously also for bulk tools as shown in FIG. 14.

A machine 200, which is designed for the inside skiving according to the invention, comprises a CNC control 201, which enables a coupling of the axes R1 and R2, respectively a coordination of the movements of the axes. The CNC control 201 may be a part of the machine 200, or it may be implemented externally and suitable for a communication-specific connection 202 with the machine 200. The corresponding machine 200 comprises a so-called “electronic gear train”, respectively “electronic or control-specific coupling of axes” in order to perform a feed movement VB of the inside skiving ring 100 with respect to the outer-toothed power skived work piece 50 (the work piece 50 is not visible in FIG. 15A, because it sits in the interior space 71). The coupledly moving of the inside skiving ring 100 and the work piece 50 is performed such that during the machining phase, a relative movement between the inside skiving ring 100 and the work piece 50 results, which corresponds to a relative movement of a helical gear. The electronic gear train, respectively the electronic or control-specific coupling of axes enables a synchronization in terms of the rotational frequency of at least two axes of the machine 200. Herein, at least the rotation axis R1 of the tool spindle 170 is coupled with the rotation axis R2 of the work piece spindle 180. In addition, preferably in all embodiments, the rotation axis R1 of the tool spindle 170 is coupled with the axial feed movement VB in the direction R2. This axial feed movement VB results from a superposition of the movements 204 (vertically) and 208 (horizontally). In addition, the work piece spindle 180 can be shifted linearly by means of a (rotation-) carriage 205 parallel to a pivot axis SA, as represented by a double arrow 206. In addition, the (rotation-) carriage 205 together with the work piece spindle 180 and the work piece 50 can be rotated about the pivot axis SA, as indicated by a double arrow 207. The intersection angle of axes Σ can be set by the rotation about the pivot axis SA. The distance AA between axes is set by the linear shifting movement 207.

Preferably, a machine 200 is employed, which is based on a vertical arrangement as shown in FIG. 15A and FIG. 15B. In such a vertical arrangement, either the inside skiving ring 100 together with the tool spindle 170 sits above the work piece 50 together with the work piece spindle 180, or vice versa. The chips, which are generated during the skiving, fall downward due to the influence of gravity and can be removed, e.g., via a chip bed which is not shown. Therefore, the arrangement shown in the FIGS. 15A and 15B is particularly preferred, because in this arrangement, no chips can fall in the interior space 171 which is formed by the tool 100 together with the tool spindle 170.

In addition, the machine 200, which is designed for the inside skiving according to the invention, addresses the correct complex geometrical and kinematical machine settings and axes movements of the mentioned axes. Preferably in all embodiments, the machine comprises six axes. The following axis movements are preferred:
rotating the skiving tool about the first rotation axis R1;
coupledly rotating the work piece 50 about the second rotational axis R2;
rotating movement about the swivel axis SA;
linear vertical movement parallel to 204;
linear horizontal movement parallel to 206; and
linear horizontal movement parallel to 208.

It can be recognized in FIG. 15B that preferably the tool spindle 170 and/or an adapter is designed as a rotationally-shaped hollow body (e.g., as a hollow cylinder). The tool spindle 170 and/or the adapter preferably have a cup shape. The inside skiving ring 100 is fixed to the tool spindle 170 and/or the adapter. In FIG. 15B, an embodiment is shown, in which the inside skiving ring 100 is a fixed component of the tool spindle 170 and/or the adapter. The receiving openings for the cutter bars 120 may be provided directly on the tool spindle 170 and/or on the adapter. It can be recognized in FIG. 15B, that the shafts of the cutter bars 120 project radially outwardly out of the material of the tool spindle 170 and/or the adapter.

A cup-shaped tool spindle 170 and/or a cup-shaped adapter may also be implemented as a bulk tool and be equipped with cutting plates.

A cup-shaped tool spindle 170 and/or a cup-shaped adapter may, however, also be designed for fixing a separate annular inside skiving ring 100.

Due to the special configuration for the inside skiving, machines 200 having a work space AR with a maximum dimension in the direction of the distance between axes from the first rotation axis R1 to the second rotation axis R2, which is as large as the maximum outer diameter of the inside skiving ring 100, are sufficient (i.e., the diameter DA of the base body 112 together with the projecting cutting piece 111, respectively the cutter bars 120, is concerned).

In all embodiments, the inside skiving method can be applied dry or wet, wherein the use of the inside skiving method in a dry way is preferred.

The application spectrum of the inside skiving method is large and extends to the application in the manufacturing of the most different rotationally symmetrical periodical structures.

1. A method of skiving a work piece having an outer rotationally symmetric periodic structure comprising applying a skiving tool and further comprising:
rotating the skiving tool about a first rotation axis;
coupledly rotating the work piece about a second rotation axis;
performing an axial feed movement of the skiving tool with respect to the work piece in a direction parallel to the second rotation axis;
setting the first rotation axis and the second rotation axis skew relative to each other and intersecting each other at an intersection angle; and
wherein the skiving tool defines an inside skiving spanning an interior space of the skiving tool, the inside skiving ring comprises a plurality of cutting teeth each including at least one cutting edge, one cutting head tip and one cutting face, the cutting faces of all of the cutting teeth are arranged rotationally symmetric with respect to the first rotation axis on a front plane or a front-side cone surface of the inside skiving ring, and the cutting teeth project into the interior space and point in the direction of the first rotation axis.

2. The method according to claim 1, wherein the cutting faces are individually inclined with respect to the front plane or the front-side cone surface.

3. The method according to claim 1, wherein the inside skiving ring has an annular base body having an inner contour or inner mantle surface that is cylindrical or conical.

4. The method according to claim 1, wherein the cutting faces are plane surfaces or curved surfaces.

5. The method according to claim 1, wherein the work piece has a maximum outer diameter and the inside skiving ring has a minimum inner diameter at least 1.5 times greater than the maximum outer diameter of the work piece.

6. The method according to claim 1, wherein the work piece has a rolling circle diameter and the inside skiving ring has a rolling circle diameter least 1.5 times greater than the rolling circle diameter of the work piece.

7. The method according to claim 5, wherein the minimum inner diameter is at least two times greater than the maximum outer diameter of the work piece.

8. The method according to claim 6, wherein the rolling circle diameter of the inside skiving ring is at least two times greater than the rolling circle diameter of the work piece.

9. The method according to claim 1, further comprising inclining the inside skiving ring towards the work piece or away from the work piece during skiving.

10. An apparatus for skiving a work piece (50) having a rotationally symmetric periodic outer structure by applying a skiving tool, the apparatus comprising:
a skiving tool;
a tool spindle configured to fix the skiving tool;
a work piece spindle configured to fix a work piece; and
numerically controlled drives configured to coupledly perform a feed movement and to coupledly rotate the skiving tool together with the tool spindle about a first rotation axis and the work piece together with the work piece spindle about a second rotation axis;
wherein the skiving tool defines an inside skiving ring spanning an interior space, the inside skiving ring comprises a plurality of cutting teeth each including at least one cutting edge, one cutting head tip and one cutting face, the cutting faces of all of the cutting teeth are arranged rotationally symmetric with respect to the first rotation axis on a front plane or a front-side cone surface of the inside skiving ring, and the cutting teeth project into the interior space and point in a direction of the first rotation axis; and
the apparatus includes a numerical control or is connectable with a numerical control configured to set the first rotation axis and the second rotation axis skew relative to each other and intersecting each other at an intersection angle during the skiving.

11. The apparatus according to claim 10, wherein said interior space is circular.

12. The apparatus according to claim 10, wherein the cutting faces are individually inclined with respect to the front plane or the front-side cone surface.

13. The apparatus according to claim 10, wherein the work piece has a maximum outer diameter and the inside skiving ring has a minimum inner diameter at least 1.5 times greater than the outer diameter of the work piece.

14. The apparatus according to claim 10, wherein the work piece has a rolling circle diameter and the inside skiving ring has a rolling circle diameter at least 1.5 times greater than the rolling circle diameter of the work piece.

15. The apparatus according to claim 13, wherein the minimum inner diameter of the skiving ring is at least 2 times greater than the maximum outer diameter of the work piece.

16. The apparatus according to claim 14, wherein the rolling circle diameter of the inside skiving ring is at least 2 times greater than the rolling circle diameter of the work piece.

17. The apparatus according to claim 10, wherein the numerical control is configured to incline the inside skiving ring towards the work piece or away from the work piece during the skiving.

18. The apparatus according to claim 10, wherein the inside skiving ring defines a maximum outer diameter and the apparatus defines a work space having a maximum dimension defined by a distance between the first rotation axis and the second rotation axis of no more than 50% greater than the maximum outer diameter of the inside skiving ring.

19. The apparatus according to claim 17, wherein the tilt angle is between −30 degrees and +30 degrees.
